(19) United States
(12) Patent Application Publication
(10) Pub. No.: US 2026/0105332 A1
(43) Pub. Date: Apr. 16, 2026

(54) Agentic Experiences Provided by an Edge Device

(71) Applicant: MediaTek Inc., Hsinchu City (TW)

(72) Inventors: Xiaofeng Li, San Jose, CA (US); Chun-Ming Su, Hsinchu City (TW)

(21) Appl. No.: 19/354,342

(22) Filed: Oct. 9, 2025

Related U.S. Application Data
(60) Provisional application No. 63/706,785, filed on Oct. 14, 2024.

(51) Int. Cl. G06N 5/043

(52) U.S. Cl. CPC G06N 5/043

(57) ABSTRACT

Multiple predefined requests are sent to each of the artificial intelligence (AI) models deployed on a device. For each predefined request, a multi-dimensional complexity vector is obtained from inference operations of each AI model. The multi-dimensional complexity vector indicates, in each dimension, a complexity value of the inference operations. The agentic level provided by each AI model is evaluated by calculating a combination of complexity values obtained from each predefined request and averaging over the predefined requests. When receiving a user request, a required agentic level of the user request is estimated. The user request is directed to one of the AI models that provides the required agentic level.

### CROSS-REFERENCE TO RELATED APPLICATIONS

This application claims the benefit of U.S. Provisional Application No. 63/706,785 filed on October 14, 2024, the entirety of which is incorporated by reference herein.

### TECHNICAL FIELD

Embodiments of the invention relate to an agentic framework that supports artificial intelligence (AI) agents and components.

### BACKGROUND OF THE INVENTION

A user interacting with an agentic system may feel that the system behaves autonomously, such as perceiving, reasoning, acting, and adapting, rather than a passive machine. The experience of a user interacting with an agentic system is referred to as an agentic experience. The autonomous operations of the agents in an agentic system are typically based on artificial intelligence (AI) model inferences. The agents can utilize a variety of AI models for communicating with humans and accomplishing tasks. By utilizing diverse AI models, an agentic system can perceive its environment, make informed decisions, interact naturally with humans, and perform complex tasks autonomously without step-by-step human inputs. Agentic systems have the capabilities to function effectively across various domains and applications.

The AI models utilized in an agentic system may include machine learning models, deep learning models, natural language processing models, to name a few. Many of these models require a large memory footprint and computing resources. Typically, LLMs may be stored in a cloud and remotely accessible to users via networks. Cloud-based agentic systems introduce latency that impairs real-time responsiveness, particularly for time-sensitive or interactive tasks. Moreover, the use of cloud-based systems may raise privacy and data security concerns due to the transmission and remote processing of sensitive user data. However, edge devices are limited by memory size and computing resources. Thus, it is a challenge to provide an agentic system on edge devices.

### SUMMARY OF THE INVENTION

In one embodiment, a method of a device is provided. The method comprises the device sending a plurality of predefined requests to a plurality of AI models deployed on the device. From inference operations of each AI model for each predefined request, the device obtains a multi-dimensional complexity vector that indicates, in each dimension, a complexity value of the inference operations. The method further comprises evaluating an agentic level provided by each AI model. The evaluation is performed by calculating a combination of complexity values obtained from each predefined request and averaging over the predefined requests. When receiving a user request, the method further comprises estimating a required agentic level of the user request, and directing the user request to one of the AI models that provides the required agentic level.

In another embodiment, a device includes memory to store a plurality of AI models, and one or more processors coupled to the memory. The one or more processors are operative to: send each AI model a plurality of predefined requests to obtain, for each predefined request, a multi-dimensional complexity vector indicating, in each dimension, a complexity value of AI operations, and evaluate an agentic level provided by each AI model by calculating a combination of complexity values obtained from each predefined request and averaging over the predefined requests. When receiving a user request, the one or more processors are operative to estimate a required agentic level of the user request, and direct the user request to one of the AI models that provides the required agentic level.

In yet another embodiment, a method performed by an agentic manager on a device is provided. The method comprises prompting a remote AI model to perform reasoning operations based on a user request, and prompting an edge AI model on the device to perform action planning operations based on an output of the reasoning operations. The method further comprises sending action requests to one or more apps and services according to an action plan generated by the edge AI model, and generating a response to the user request based on outputs of the one or more apps and services.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to "an" or "one" embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a block diagram illustrating an agentic framework according to an embodiment.

FIG. 2 is a block diagram illustrating interactions among framework components according to one embodiment.

FIG. 3 is a block diagram illustrating an agentic system on a device having multiple levels of edge models according to one embodiment.

FIG. 4 is a flow diagram illustrating a method of a device operating multiple levels of AI models according to one embodiment.

FIG. 5 is a block diagram illustrating an agentic manager on a device using multiple groups of AI models according to one embodiment.

FIG. 6 is a flow diagram illustrating a method for an agentic manager on a device using multiple groups of AI models for privacy protection according to one embodiment.

FIG. 7 is a block diagram illustrating a hybrid multi-agent system according to one embodiment.

FIG. 8 is a flow diagram illustrating a method for edge-cloud collaboration according to one embodiment.

FIG. 9A and 9B are diagrams illustrating data synchronization between an edge device and the cloud according to one embodiment.

FIG. 10A and FIG. 10B illustrate a synchronization scenario in which a cloud data chunk and an edge data chunk overlap in a timeslot according to one embodiment.

FIG. 11A and FIG. 11B illustrate another synchronization scenario in which a cloud data chunk and an edge data chunk completely overlap in a timeslot according to one embodiment.

FIG. 12 is a flow diagram illustrating a method for agentic data synchronization between devices of a user according to one embodiment.

FIG. 13 is a block diagram illustrating a device in an agentic system according to one embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation. As used herein, the term “and/or” includes any and all combinations of one or more of the associated listed items.

In the following description, the term “agentic manager” refers to a software application that can make autonomous decisions based on available and inferred information to drive other applications (“apps”) or services. The term “agentic app” (abbreviated as “app”) refers to a software application that can be commanded and/or orchestrated by an agentic manager and take actions to provide services accessible to users, other apps, software, and/or systems. Although the term “app” or “apps” is used throughout the disclosure, the method and system described herein are not limited to an on-device app. In some embodiments, the method and system described herein are applicable to a service such as a Web service provided by a cloud service provider, an on-device service (e.g., system service, embedded service), etc. The term “agent” refers to a software module that performs autonomous operations to serve a user, and may use one or more AI models in performing the autonomous operations. An example of an agent is an agentic manager.

The term “cloud” refers to a remote system of server computers, storage, and software, providing services to edge devices over a network, such as a public network or a private network. The term “edge device” (abbreviated as “device”) refers to a device that sits at the boundary of a local network and a wide-area network (e.g., the Internet) and provides an entry point to the wide-area network. Non-limiting examples of edge devices include smartphones, wearable devices, laptops, personal computers, Internet-of-things (IOT) devices, navigation devices, infotainment devices, robotic devices, smart home appliances, smart light/switches, etc. The term “AI model” (abbreviated as “model”) as used herein includes and is not limited to: machine learning models, deep learning models, customized learning models, natural language processing models, large language models (LLM), multi-modal models, neural networks and variations thereof, etc. The term “cloud AI model” or “cloud model” refers to an AI model in the cloud, and “edge AI model” or “edge model” refers to an AI model installed on an edge device.

The term “edge nodes” (abbreviated as “nodes”) herein encompasses virtual machines (VMs) and physical devices such as edge devices. A system may include multiple nodes, which may be VMs, edge devices, or a combination of both.

The agentic manager(s) and the apps working together are “agentic” in that they can make autonomous decisions to achieve a given goal, for example, a goal given by a user or by another app or by another device. The autonomous decisions may be based on learned data, metadata, pre-configured data, a combination of these data, etc. In one embodiment, the agentic manager(s) use AI models to perform AI operations. In one embodiment, one or more of the apps may also use AI models to perform AI operations.

The agentic framework described herein is deployed on an agentic system. Thus, in the following description, the terms “agentic framework” and “agentic system” may be used interchangeably. The term “agentic system” refers to a system in which an agentic framework is deployed. In one embodiment, an agentic system may be a device. In another embodiment, an agentic system may be a distributed network of nodes.

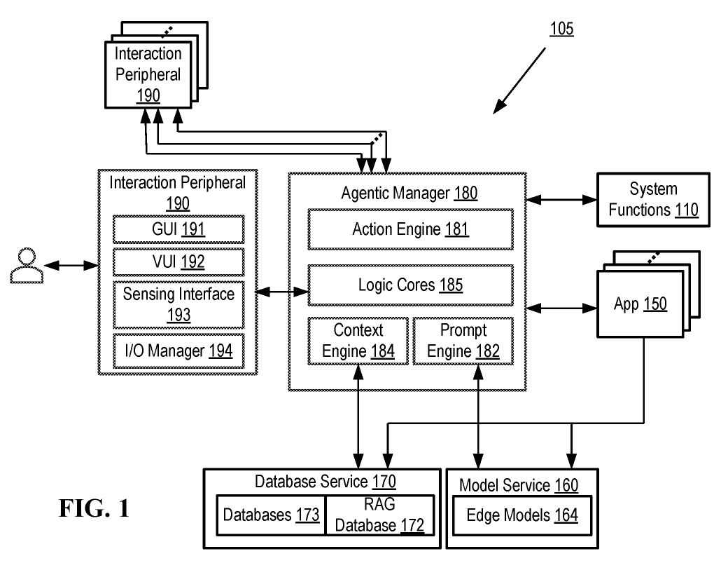

FIG. 1 is a block diagram illustrating an agentic framework 105 (“framework 105”) according to an embodiment. Non-limiting examples of the framework components in the framework 105 include an agentic manager 180, an agentic app (“app 150”), a model service 160, a database service 170, and one or more interaction peripherals 190. In one embodiment, the framework 105 may include multiple agentic manager 180, multiple apps 150, and/or multiple interaction peripherals 190. The agentic manager 180 is an agentic management application operative to manage the apps 150, and interact with the model service 160, the database service 170, the interaction peripherals 190, and users. The agentic manager 180 may also access apps and/or AI models in the cloud.

The model service 160 manages the AI models in the framework 105. These AI models are installed on one or more devices, and, therefore, are referred to as edge models 164. The edge models 164 may be accessed by the agentic manager 180 and some of the apps 150. The edge models 164 may include base models, low-rank adaptation (LoRa) models, ControlNet models, and other additional models. Each model is described by corresponding model metadata, which may be stored in databases 173 and/or a retrieval augmented generation (RAG) database 172 to facilitate fast searching. The databases 173 can be searched by keywords or other means. The RAG database 172 is also referred to as a vector embedding database or embedding database. The vector embeddings (also referred to as “embeddings”) are a numerical representation of the semantics of the stored data. An embedding database enables an efficient and accurate search for semantically similar information. Embeddings are usually, but not limited to, high-dimensional vectors encoding semantic contexts and relationships of information.

The database service 170 manages the databases 173 and the RAG database 172. In one embodiment, the model metadata may be stored in the RAG database 172 for vector embedding search (also referred to as “similarity search”) and similarity ranking. Similarity ranking refers to the ranking of the search results according to their similarity to a search criterion, e.g., search for a target model that meets the requirements of an app 150. The model service 160 may automatically set a target model of an app 150 according to the model requirements indicated in the app metadata. The app metadata describes the features of the app 150 and the requirements on the models that the app 150 uses. The app metadata may be converted by the database service 170 into vector embeddings and stored in the RAG database 172. In one embodiment, the app metadata describes what action requests that a given app can accept. The app metadata may further specify a specific model for the given app to use, or specify the requirements for a model to be used by the given app. In some embodiments, the app metadata may also describe one or more rules or hints that can be used by the agentic manager 180 to call the given app.

In one embodiment, the agentic manager 180 includes an action engine 181, a prompt engine 182, and a context engine 184, the operations of all of which are coordinated by logic cores 185. The agentic manager 180 interacts with the apps 150, the model service 160, and the database service 170. The agentic manager 180 also interacts with one or more users via the one or more interaction peripherals 190. The agentic manager 180 has access to the edge models 164. In some embodiments, the agentic manager 180 also has access to system functions 110, which provides system built-in functionalities in the device where the agentic manager 180 is located. Non-limiting system built-in functions include services such as time, location, device maker information, device ID information such as phone number, device settings such as font size, device control functions such as flight mode, etc. The system functions 110 are different from the apps 150 in that the system functions 110 are built-in functions of the system, while the apps 150 are independently developed capabilities.

In one embodiment, each interaction peripheral 190 is an I/O peripheral device that can interact with users and/or the environment. The interaction peripheral 190 provides various forms of I/O for a user to interact with the framework components. The operations of the interaction peripheral 190 may be managed by an I/O manager 194. For example, the interaction peripheral 190 may receive user inputs via touch, voice, text, and/or the like. Non-limiting examples of the interaction peripheral 190 may include cameras, sensors, displays, speakers, microphones, IoT devices, robots, etc. The interaction peripheral 190 also produces outputs to users and/or other I/O devices. In some embodiments, the interaction peripherals 190 may include IoT devices having service agents (e.g., software, firmware, and/or hardware components) installed thereon, where the service agents are controllable by the agentic manager 180. The interaction peripheral 190 may support one or more of: a graphic user interface (GUI) 191, a voice user interface (VUI) 192, a sensing interface 193, and/or other I/O interfaces. The GUI 191 may provide graphical icons or links on a display screen for a user to select, and generate graphical outputs for the user to view. The VUI 192 may provide speech-to-text functions (e.g., automatic speech recognition (ASR)) and text-to-speech (TTS) functions to convert user speech input into text, and text output to speech. The sensing interface 193 may include touch sensors to sense users’ touch, cameras to detect users’ gestures, etc.

The framework 105 provides edge-device users with an agentic experience in a user-intuitive way. The agentic manager 180 may utilize one or more edge models 164 for natural language processing, speech recognition, and speech generation. In one embodiment, the agentic manager 180 may be invoked by a trigger phrase from the user, e.g., “hi there”.

In one embodiment, the framework 105 is deployed on multiple nodes, which includes devices, VMs on one or more devices, or a combination of both. The devices in the framework 105 are connected by a network.

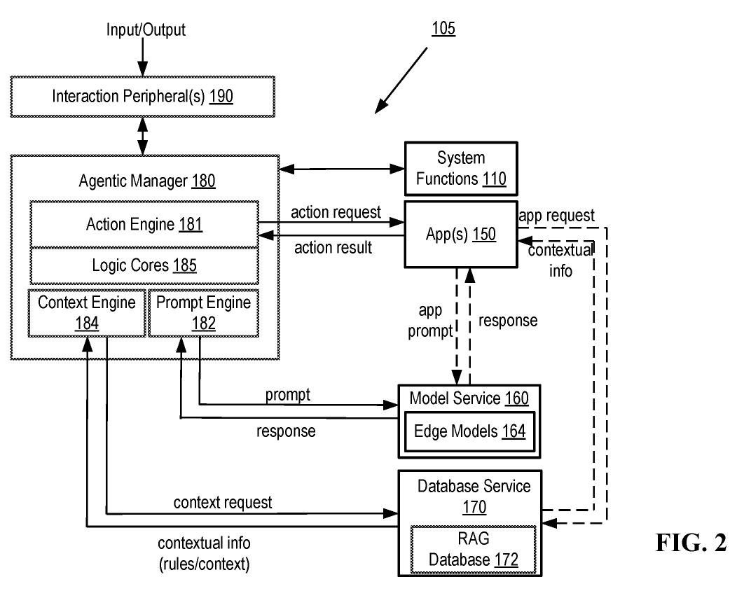

FIG. 2 is a block diagram illustrating interactions among framework components according to one embodiment. Upon receiving a user request, the interaction peripheral 190 forwards the user request to the agentic manager 180. The user request may specify a task. The agentic manager 180 (more specifically, the context engine 184) sends a context request to the database service 170 for contextual information of the user request, such as the identities of one or more apps providing the requested service. The database service 170 performs a similarity search in the RAG database 172 based on the similarity between the stored app metadata and the phrases in the user request. In one embodiment, the contextual information generated from the similarity search contains local information and/or user preference information that can be used by the agentic manager 180 to prompt one of the edge models 164, referred to as a target model. The contextual information can improve the quality and the precision of the response generated by the target model, and, thereby, enhance the user experience. In one embodiment, the contextual information may identify one or more of the apps 150 as target apps to provide the service requested by the user.

After receiving the contextual information, the agentic manager 180 (more specifically, the prompt engine 182) sends a prompt to the agentic target model, where the prompt incorporates the contextual information. For example, the prompt may include a request for planning actions. The target model generates a response including an action plan, indicating the action requests that the agentic manager 180 can send to a target app. The agentic manager 180 (more specifically, the action engine 181) sends an action request to the target app. The target app executes the action and returns an action result to the agentic manager 180. In one embodiment, the target app may use the database service 170 and/or the model service 160 to respond to the action request. In some scenarios, the agentic manager 180 may send additional action requests to one or more apps according to the action plan. The agentic manager 180 may send the action result to the user via the interaction peripheral 190 for user’s further input or confirmation. When the task specified by the user request is completed, the agentic manager 180 sends an output to the user indicating the completion of the task. In one embodiment, operations of the agentic manager 180 are coordinated by the logic cores 185.

In one embodiment, the communication between the agentic manager 180 and the apps 150 is bi-directional. The agentic manager 180 requests the target app to take actions, and the target app sends action results to the agentic manager 180. For example, the action may be to order a burger, and the action result may be a list of burgers offered by food ordering apps. The list may be provided to the agentic manager 180 as an action result, and the agentic manager 180 may consult one or more AI models, online sources, and/or the on-device databases to supplement the list with relevant information (e.g., nutrition and/or price) before generating an output to the user. In some scenarios, the action result from the target app to the agentic manager 180 may be an indication of “success” or “failure” with respect to the food order. In carrying out the action request, the target app may use one or more AI models to generate the action result. In some scenarios, the target app may generate output without using AI models.

Before describing the management of the framework component in a distributed framework, it is helpful to first explain the terms “user request’ and “user session.” A user request is a request sent by a user to ask the agentic manager 180 to perform a task. A user session is a session that starts when a user sends a request to the agentic manager 180 for performing a task and ends when the task is completed. As a non-limiting example, upon receiving a user request, the agentic manager 180 is operative to process the user request, access a model, access a database, request a target app to take action, and output a response to the user. A user session may include one or more iterations of interactions between the user and the agentic manager 180. For example, the agentic manager 180 may ask the user for clarification, and the user may provide feedback to the agentic manager 180.

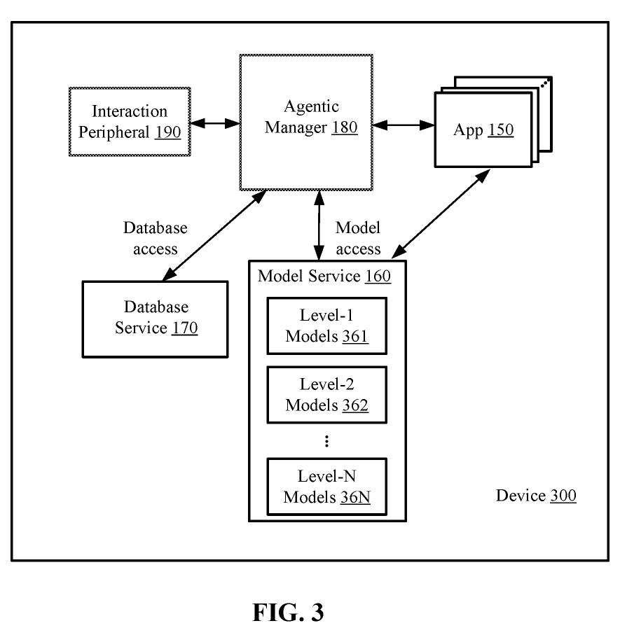

FIG. 3 is a block diagram illustrating an agentic system deployed on a device 300 having multiple levels of AI models according to one embodiment. The agentic manager 180 has access to multiple levels of AI models 361, 362, …, 36N, where N is a positive integer. The level of an AI model represents the capability level of that model. For example, level-1 models 361 are the basic models that handle simple requests, level-2 models 362 can handle more complex requests than level-1 models 361, and so on. A higher-level model typically has more parameters and requires more powerful hardware to run it than a lower-level model. In the description herein, a level-k model is a higher-level model than a level-n model when k > n.

When the agentic manager 180 receives a user request, it prompts an AI model and triggers the actions of one or more apps 150 to fulfill the user request. During the process, the agentic manager 180 may interact with the user in multiple iterations, e.g., it may ask the user to input missing parameters for an action, it may ask the user to confirm a follow-up action, and/or the user may give a command that modifies the original request, etc. The complexity of the process for fulfilling a user request may depend on the nature of the request and the capability level of the AI models available for use by the agentic manager 180. A more capable (i.e., higher-level) AI model may be able to help fulfill a user request that requires multiple actions across multiple apps 150 as well as intermediate user interactions. A less capable (i.e., lower-level) AI model may help to trigger a single action of a single app 150 without intermediate user interactions. It is understood that the apps 150 herein can extend to services (e.g., system services, application domain-specific services, cross-domain services, etc.) that can be invoked by the agentic manager 180 to fulfill a user request.

In the device 300, each AI model provides a level of agentic experience (“agentic level”) to the user. In one embodiment, the AI model’s capability level is the agentic level that the AI model can provide. A higher agentic level means a higher level of agentic experience and requires the support of a higher-level hardware platform. In one embodiment, each edge model on a device is labeled with an agentic level that the edge model can provide, e.g., a level-k model can provide up to a level-k agentic level.

In one embodiment, agentic levels are characterized according to a set of complexity indicators, also referred to as a multi-dimensional complexity vector. Each dimension of the multi-dimensional complexity vector is a complexity value of AI operations. Each complexity value may be zero or a positive number. A multi-dimensional complexity vector that includes more non-zero values and/or larger non-zero values corresponds to a higher agentic level.

In one embodiment, benchmarking cases are used to test each edge model to determine its agentic level. For example, a benchmarking case may include sending a predefined request (e.g., a request for executing a task) to a given model (which is an edge model) and collecting the complexity values of the given model’s inference operations in response to the predefined request. The complexity values collected this way may include, but are not limited to: the total number of actions of one or more apps and services triggered by the given model, the total number of apps and services triggered by the given model, the total number of user interactions between a user and the given model, the amount of user profile data and the amount of contextual data used by the given AI model for inference. For each predefined request sent to a given model, all of the complexity values in a multi-dimensional complexity vector are added together to obtain a sum. Then an average of the sums over all predefined requests in the benchmarking cases is calculated. The resulting average value corresponds to the given model’s agentic level; i.e., the larger the resulting average value, the higher the agentic level.

The device 300 can be configured to use the edge models that are supported by the device and provide a target agentic level. These edge models on the device 300 may be managed by the model service 160 and identified in model metadata accessible to the agentic manager 180. Thus, platforms of different capability levels, from smart phones, smart appliances, personal computers, to server systems, can run agentic systems of different agentic levels. In one scenario, the device 300 may receive an upgrade such as additional memory which increases the device’s capability to run more powerful edge models. In this scenario, the device 300 may activate one or more already-deployed edge models that provide an agentic level supported by the upgraded device.

The capability level of an edge device is determined by the highest-level models that can run on the edge device. In one embodiment, the device 300 has one or more levels of edge models deployed thereon. When receiving a user request, the agentic manager 180 on the device 300 may direct the user request to an edge model that provides an agentic level required to satisfy the complexity level of the user request. In one embodiment, an agentic level required for a user request can be estimated based on a predefined request category to which the user request belongs. For example, a calendar scheduling request may require a low agentic level and be directed to a low-level edge model, and a food ordering request (with potentially multiple rounds of user-model interactions) may require a high agentic level and be directed to a high-level edge model.

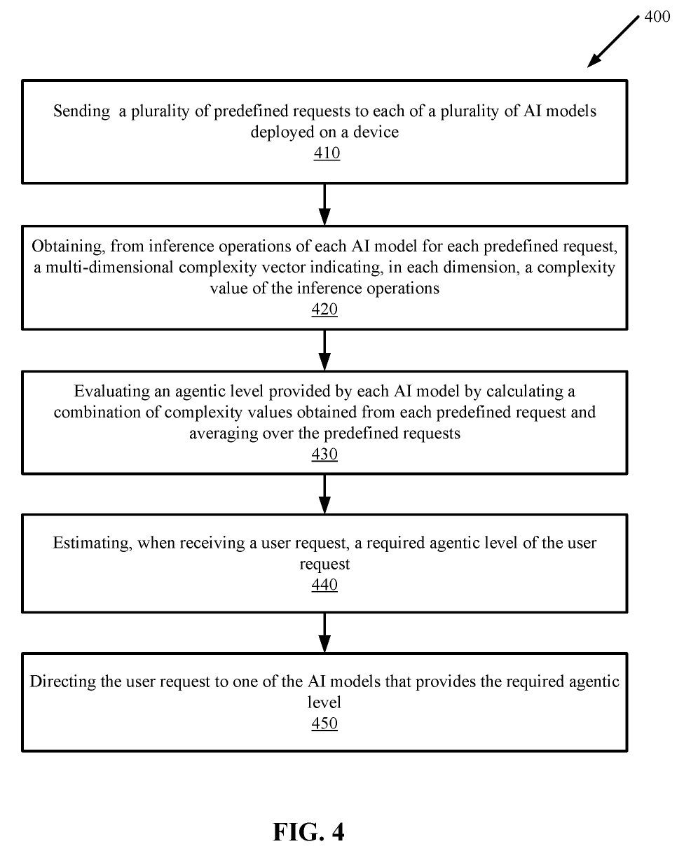

FIG. 4 is a flow diagram illustrating a method 400 of a device operating multiple levels of edge models according to one embodiment. In one embodiment, the method 400 may be performed by the device 300 and the agentic manager 180 in FIG. 3. In one embodiment, the method 400 begins at step 410 when the device sends a plurality of predefined requests to a plurality of AI models deployed on the device 300. These predefined requests may be the benchmarking cases. From inference operations of each AI model for each predefined request, the device obtains at step 420, a multi-dimensional complexity vector that indicates, in each dimension, a complexity value of the inference operations. At step 430, an agentic level provided by each AI model is evaluated. The evaluation is performed by calculating a combination of complexity values obtained from each predefined request and averaging over the predefined requests. At step 440, when receiving a user request, the agentic manager on the device estimates a required agentic level of the user request. At step 450, the agentic manager directs the user request to one of the AI models that provides the required agentic level.

In one embodiment, one of the complexity values indicates a total number of actions of apps and services triggered by a given AI model in response to a predefined request. One of the complexity values indicates a total number of apps and services triggered by a given AI model in response to a predefined request. One of the complexity values indicates a total number of user interactions between a user and a given AI model when the given AI model responds to a predefined request. In one embodiment, the complexity values indicate an amount of user profile data and an amount of contextual data used by a given AI model for inference in response to a predefined request. In one embodiment, the required agentic level of the user request is estimated based on a predefined request category to which the user request belongs.

In one embodiment, when calculating the combination of complexity values, for each predefined request, the device may add all complexity values in the multi-dimensional complexity vector to obtain a sum. In one embodiment, the device may activate one or more of the AI models that provide a given agentic level supported by the device.

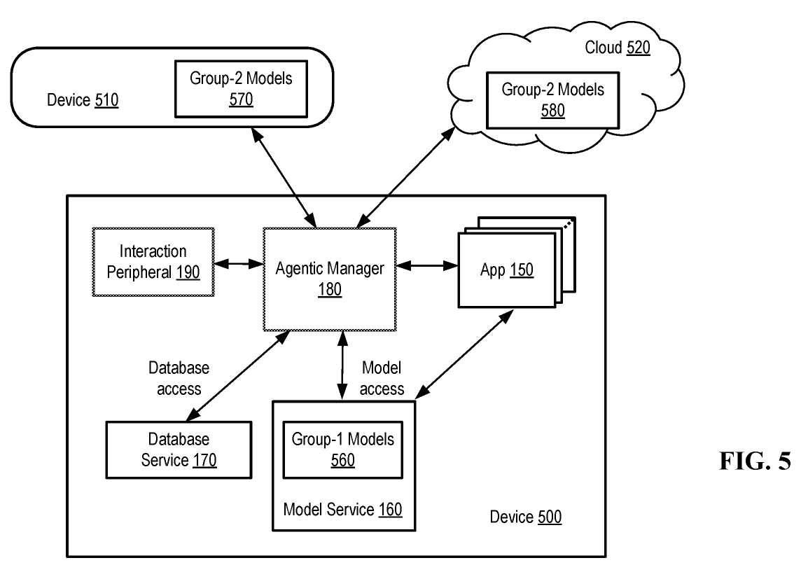

FIG. 5 is a block diagram illustrating the agentic manager 180 on a device 500 using multiple groups of AI models for privacy protection according to one embodiment. Although two groups of AI models (group-1 and group-2) are shown in this example, it is understood that privacy protection may be achieved by using more than two groups of AI models.

When the agentic manager 180 receives a user request, it prompts an AI model and requests the actions of one or more apps 150 to fulfill the user request. The agentic manager 180 requests an action of an app 150 by calling its API and/or by accessing the app metadata in a database managed by the database service 170. The agentic manager 180 may send some of the app metadata together with other information to the AI model in order to form a response to the user or to formulate another action request. The app metadata may contain the user’s private information that the user does not want to send out of the device 500.

According to embodiments of the invention, the agentic manager 180 uses two groups of models to resolve the privacy issue. Group-1 models 560 stay in the same edge device (e.g., device 500) as the app metadata and the user data, while group-2 models 570 and 580 are stored in the cloud 520 and other devices (e.g., device 510), respectively. The agentic manager 180 uses the group-2 models 570 and 580 for reasoning and the group-one models 560 for action planning. Reasoning involves analyzing a request/question and making predictions, and action planning involves organizing actions to achieve a goal. The group-two models 570 and 580 are also referred to as remote AI models.

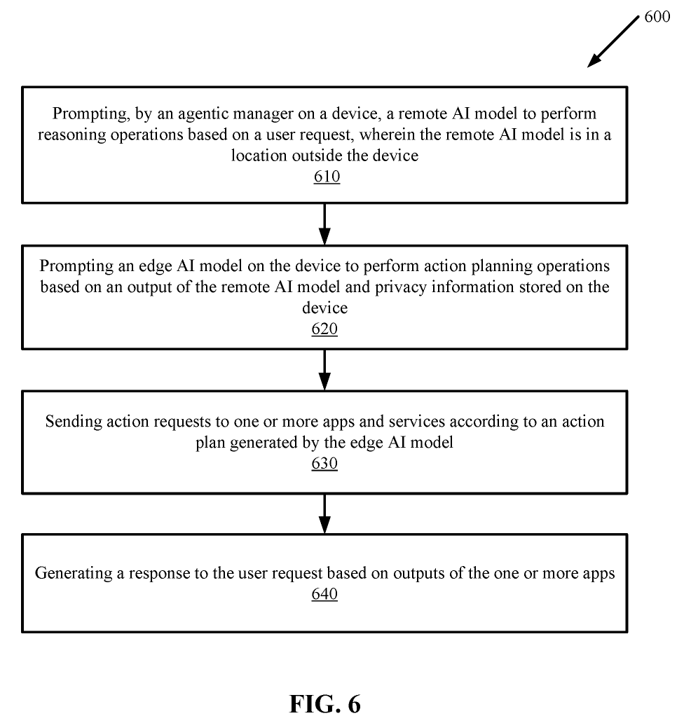

FIG. 6 is a flow diagram illustrating a method 600 for an agentic manager on a device using multiple groups of AI models for privacy protection according to one embodiment. Referring also to FIG. 5, an example of the agentic manager herein may be the agentic manager 180 on the device 500. The method 600 starts at step 610 when an agentic manager on a device prompts a remote AI model to perform reasoning operations based on a user request. The remote AI model is at a location outside the device. For example, the remote AI model may be located on another device (e.g., device 510) or in the cloud 520. At step 620, the agentic manager prompts an edge model on the device to perform action planning operations based on an output of the remote AI model. At step 630, the agentic manager sends action requests to one or more apps and services according to an action plan generated by the edge model. At step 640, the agentic manager generates a response to the user request based on outputs of the one or more apps and services.

In one embodiment, when prompting the edge AI model, the method further comprises sending privacy information stored on the device to the edge AI model for the action planning operations. In one embodiment, the remote AI model resides on a cloud server communicatively coupled to the device. In one embodiment, the remote AI model resides on another device communicatively coupled to the device.

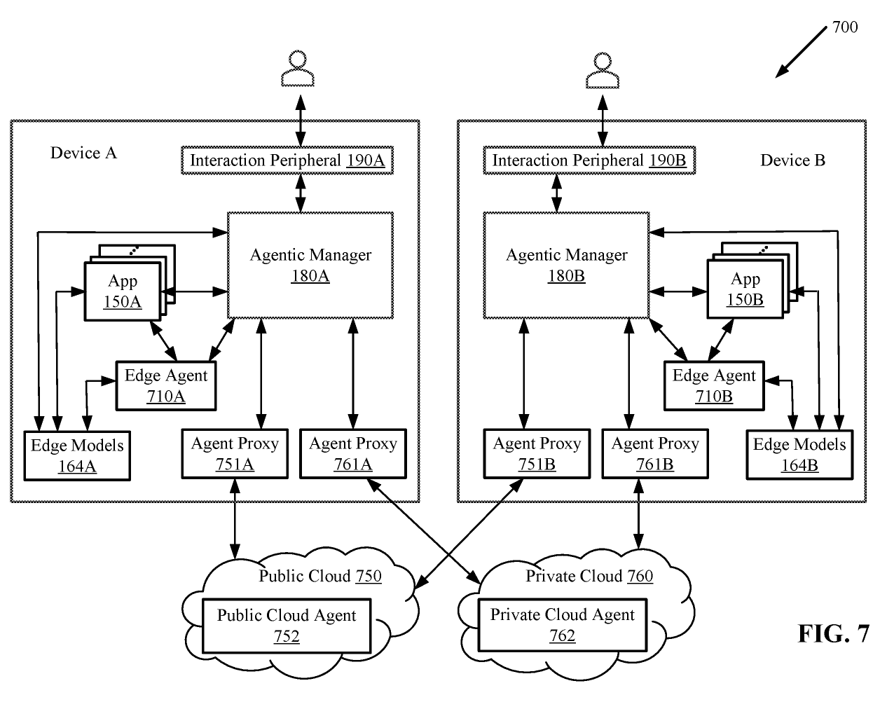

FIG. 7 is a block diagram illustrating a hybrid multi-agent system 700 according to one embodiment. The hybrid multi-agent system 700 includes one or more edge devices (two are shown in this example) and cloud servers, and utilizes both edge models and cloud models. The characteristics of edge models and cloud models are usually different. For example, edge models have the benefits of personalization, while cloud models can handle more complex problems.

Edge agents and cloud agents use edge models and cloud models, respectively, to process requests. An edge agent is located on an edge device and focuses on providing personalized services, such as apps services, settings, home control, vehicle control, etc. In the example of FIG. 7, edge agents include agentic managers 180A and 180B on device_A and device_B, respectively. Each of the agentic managers 180A and 180B is responsible for managing and coordinating the operations of apps, services, and the other agents on the device. These other agents may include domain-specific agents and cross-domain agents. A domain-specific agent is specialized in a specific knowledge or application domain, e.g., a calendar agent specialized in scheduling meetings, sending reminders, and other time-based tasks, an email agent specialized in email-related tasks such as reading, writing, and summarizing emails, etc. A cross-domain agent can integrate information from multiple knowledge or application domains. For example, the agentic managers 180A and 180B are both cross-domain agents.

In one embodiment, the cloud may include a public cloud 750 and/or a private cloud 760. The public cloud 750 may be provided to the public and is accessible via a public communication network (e.g., the Internet), while the private cloud 760 may be dedicated to an organization and is accessible via a private communication network (e.g., a virtual private network (VPN)). A public cloud agent 752 is located in the public cloud 750 and offers general Web services to the public. A private cloud agent 762 is located in the private cloud 760 and focuses on organization-specific services.

The hybrid multi-agent system 700 executes a task when triggered by an agent (“initial trigger agent”). The term “agent” according to the example of FIG. 7 refers to a cloud agent (e.g., the public cloud agent 752 or the private cloud agent 762) or an edge agent (e.g., the agentic manager 180A or 180B, or the edge agent 710A or 710B). The initial triggering agent may trigger one or more other agents, which may be on the same device, another device, and/or in the cloud. In the examples below, a user sends an initial request to an initial triggering agent. The initial triggering agent may send a request to one or more other agents in the system 700, and these other agents may send further requests to some other agents in the system 700, and so on, until the initial request is fulfilled. The agents that participate in the fulfillment of the initial request are referred to herein as collaborating agents. The collaborating agents may use one or more AI models to generate responses to the received requests. Some of these requests may be sent via edge-cloud communication networks that connect the cloud (e.g., the public cloud 750 and/or the private cloud 760) to one or more devices (e.g., device_A and/or device_B). Non-limiting examples of the edge-cloud communication networks include a VPN, the Internet, etc. Some of these requests may be sent via inter-device connections such as Wi-Fi, Bluetooth, near-field communication (NFC), etc. Each request may indicate a sub-task for completing at least a portion of the task requested in the user’s initial request. Subsequently, the initial triggering agent may send out an indication of task completion status (e.g., success or failure) based on responses to the requests.

As one example, the private cloud agent 762 can trigger an edge agent. When the private cloud agent 762 (e.g., a company’s cloud agent) receives a bug report from a customer, the private cloud agent 762 notifies an engineer’s edge agent (e.g., the agentic manager 180A) on an edge device (e.g., device_A) for this bug via a secure network (e.g., a VPN) between the private cloud 760 and the edge device. The private cloud agent 762 communicates with the agentic manager 180A via an agent proxy 761A. The agentic manager 180A notifies a domain-specific edge agent 710A (e.g., a calendar agent) to add a bug deadline reminder to the engineer’s calendar. The edge agent 710A may use an edge model 164A to process the notification and then send a receipt confirmation to the private cloud agent 762. The private cloud agent 762 responds to the customer that the bug report is being investigated.

In one embodiment, an edge agent can trigger a public cloud agent and another edge agent. For example, via respective interaction peripherals 190A and 190B, two users request their respective agentic managers 180A and 180B on their respective device_A and device_B to plan a movie date. Based on the semantics in the user requests, the agentic managers 180A and 180B each send a request to the public cloud agent 752 to search for movie schedules that satisfy their respective users’ time constraints and preferences. In this example, the public cloud agent 752 may be a domain-specific agent such as a search engine for movies. The two agentic managers 180A and 180B communicate with the public cloud agent 752 through their respective agent proxies 751A and 751B via an edge-cloud communication network (e.g., the Internet). The agentic managers 180A and 180B exchange the search outcome and collaborate to select a movie and a mutually agreeable time for the movie date. The agentic managers 180A and 180B then notify their respective calendar agents (e.g., the edge agents 710A and 710B) to add the movie date to the calendars, and confirm the movie date with their users. In one embodiment, the agentic managers 180A and 180B and the edge agents 710A and 710B may use the respective edge models 164A and 164B to process requests and notifications. In one embodiment, the agentic managers 180A and 180B and the edge agents 710A and 710B may invoke apps 150A and 150B to generate outputs in response to the user requests.

In one embodiment, an edge device may use different agent proxies to bridge to different cloud agents. For example, different agent proxies (e.g., 751A, 751B, 761A, and 761B) can implement different communication protocols, authentication and access control, APIs, etc, to handle the different communication requirements of the different cloud agents (e.g., 752 and 762), which may be hosted by different cloud providers.

The main entry agent on an edge device, e.g., the agentic manager (180A or 180B), has the information or has access to the information for determining which domain-specific edge agent to collaborate with. In some embodiments, the agentic manager (180A or 180B) can obtain the information from an on-device RAG database or a fine-tuned edge model. For some edge devices such as mobile phones, the main entry agent may be a voice assistant, or may incorporate a voice assistant, which can respond to a user’s voice command and trigger other agents’ actions.

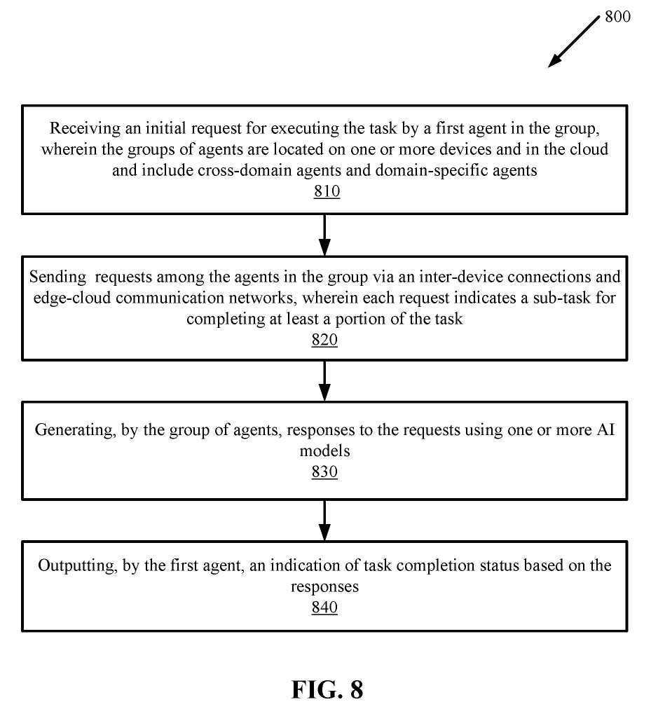

FIG. 8 is a flow diagram illustrating a method 800 for edge-cloud collaboration according to one embodiment. The method 800 is performed by a group of agents to collaboratively execute a task. Referring also to FIG. 7, The term “agent” herein, unless specifically indicated otherwise, refers to a cloud agent (e.g., the public cloud agent 752 or the private cloud agent 762) or an edge agent (e.g., the agentic manager 180A or 180B, or the edge agent 710A or 710B).

The method 800 begins at step 810 when a first agent in a group of collaborating agents receives a first request for executing the task. The groups of agents are located on one or more devices and in the cloud, and include cross-domain agents and domain-specific agents. At step 820, the group of agents send requests among themselves via inter-device connections and edge-cloud communication networks. Each request indicates a sub-task for completing at least a portion of the task. At step 830, the group of agents generate responses to the requests using one or more AI models. At step 840, the first agent outputs an indication of task completion status based on the responses.

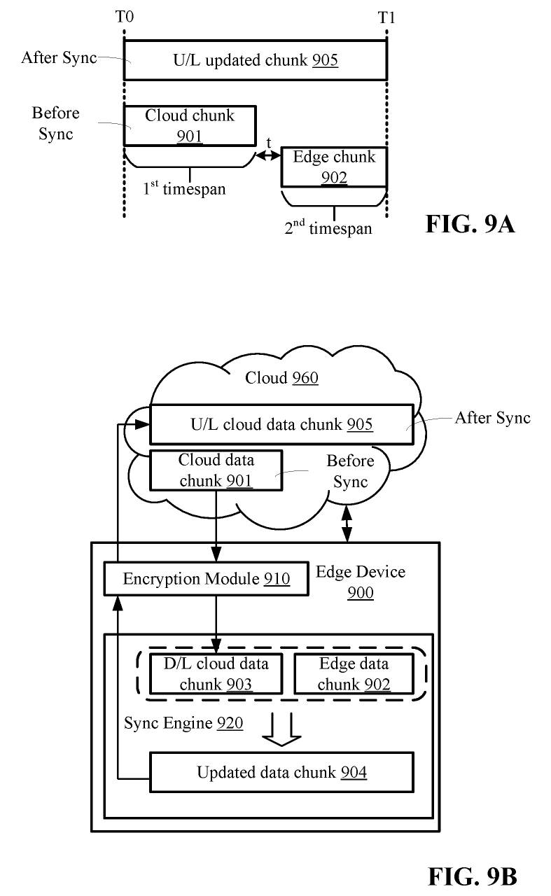

FIG. 9A and 9B are diagrams illustrating data synchronization between an edge device 900 and the cloud 960 according to one embodiment. A person having multiple devices may need to synchronize personal data between the devices from time to time. Each device’s runtime may be divided into multiple timeslots (e.g., the timeslot represented by T0 to T1 in FIG. 9A). The devices may take turns to synchronize with the cloud for each timeslot.

A user’s personal data synchronized among the user’s devices may include agentic data. The agentic data records the user’s interactions with an agent system. The agentic data may include a prompt summary, user preferences, user’s personal data, histories of user sessions, histories of the user’s interactions with one or more AI models, and timeslot information. The agentic data in each timeslot is referred to as a data chunk. A data chunk stored in an edge device is referred to as an edge data chunk, and a data chunk stored in the cloud is referred to as a cloud data chunk. The agentic data includes the starting time and the ending time (or the timespan) of each data chunk in each timeslot.

For privacy concerns, only encrypted data can be stored in the cloud server unless the cloud server is fully trusted. The following description pertains to scenarios in which the cloud server is not fully trusted, and, therefore, data synchronization is performed at the edge device.

To synchronize agentic data, a user’s device first determines whether an edge data chunk stored in the device overlaps in time with the corresponding cloud data chunk. Corresponding data chunks are the agentic data recorded in the same timeslot and stored in different locations. The corresponding cloud data chunk may be uploaded from the user’s one or more other devices.

In one embodiment, for each edge data chunk on a device, the device monitors the discrepancies between the edge data chunk and a corresponding cloud data chunk. The discrepancies can be detected by the device comparing the hash values of the edge data chunk and the corresponding cloud data chunk. The device may decrypt the cloud data chunk before the comparison. The device performs data synchronization when the hash values are different.

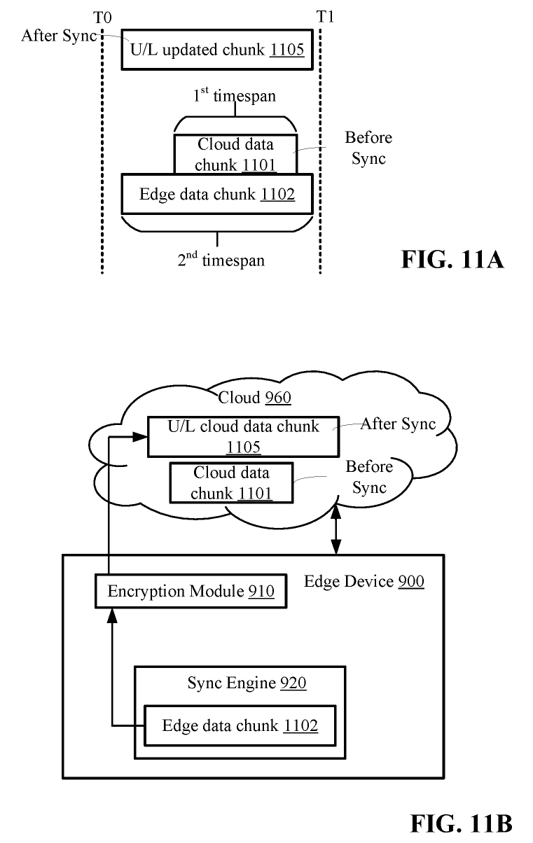

In the example of FIG. 9A and FIG. 9B, an edge data chunk 902 and a corresponding cloud data chunk 901 has no overlap in the timeslot (also referred to as a time interval) T0-T1. For example, a user’s device A and device B may generate agentic data that have different timespans without any overlap in time. A data chunk generated by device A in the timeslot T0-T1 may be encrypted and uploaded to a cloud server and become the cloud data chunk 901. The cloud data chunk 901 may contain a set of user preferences obtained from the user using device A to interact with one or more AI models. Afterwards, device B detects a data discrepancy between an edge data chunk 902 (which is on device B and generated in the timeslot T0-T1) and the cloud data chunk 901. The edge data chunk 902 may contain another set of user preferences obtained from the user using device B to interact with one or more AI models. Device B downloads and decrypts the cloud data chunk 901 (referred to as the downloaded cloud data chunk 903). Device B may first obtain and compare the timespan of the edge data chunk 902 with the timespan of the cloud data chunk 901 before the downloading. In some scenarios to be described with reference to FIG. 11A and FIG. 11B, device B may skip the downloading when it is determined that the timespan of the edge data chunk 902 completely covers the timespan of the cloud data chunk 901.

Device B includes an encryption module 910 to perform both data encryption and decryption. Device B further includes a sync engine 920 to calculate an updated data chunk 904, which contains the agentic data (e.g., user preferences data) in both the downloaded cloud data chunk 903 and the edge data chunk 902. The updated data chunk 904 may be calculated based on the set of user preferences in the edge data chunk 902 and the set of user preferences in the downloaded cloud data chunk 903 and contain the updated user preferences. The sync engine 920 may use an AI model (e.g., a large language model (LLM)) to extract a new set of user preferences from the downloaded cloud data chunk 903 and the edge data chunk 902. The sync engine 920 may use an AI model (e.g., an LLM)) to summarize the user preferences in the downloaded cloud data chunk 903 and the edge data chunk 902. The encryption module 910 then encrypts the updated data chunk 904. Device B then uploads to the cloud 960 the encrypted and updated data chunk, which is referred to as an uploaded (U/L) cloud data chunk 905. FIG. 9B shows that the cloud 960 before the synchronization stores the cloud data chunk 901, and after the synchronization stores the U/L cloud data chunk 905. After the synchronization, any of the user’s devices including device A and device B can download the U/L cloud data chunk 905 for inference operations.

In one embodiment, the calculations performed by the sync engine 920 may depend on the time gap (t) between the timespans of the cloud data chunk 901 and the edge data chunk 902. When the spacing is less than a predetermined and configurable time threshold, the two data chunks may be merged and a new set of user preferences is generated. When the spacing is greater than the predetermined and configurable time threshold, the two data chunks may be treated as individual events and a summary of two sets of user preferences is generated.

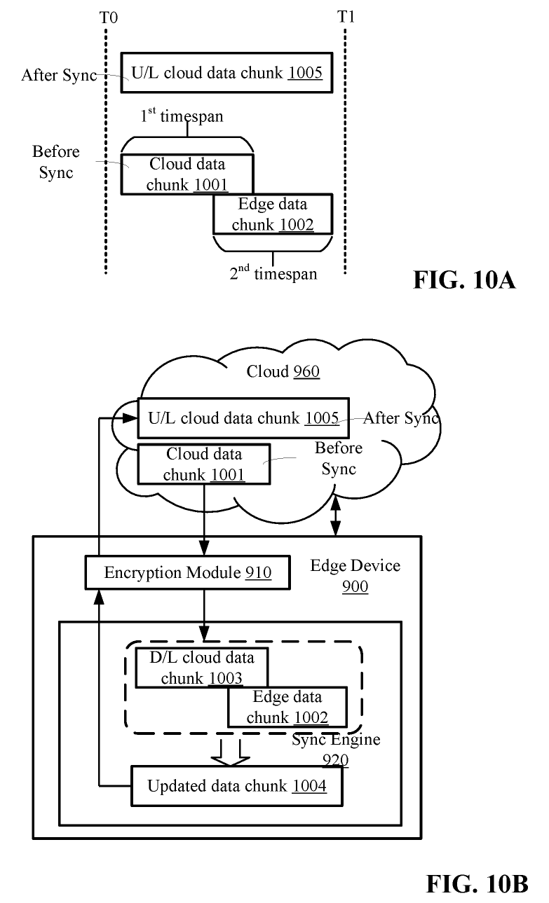

Synchronization conflict can happen when a cloud data chunk and an edge data chunk overlap in time. This may happen when two or more of a user’s devices operate their respective agentic managers on behalf of the user at the same time. FIG. 10A and FIG. 10B illustrate a synchronization scenario in which a cloud data chunk 1001 and an edge data chunk 1002 overlap in a timeslot according to one embodiment. Similar to the example in FIG. 9A and FIG. 9B, device B detects a data discrepancy between the edge data chunk 1002 and the corresponding cloud data chunk 1001 in the interval T0-T1. The cloud data chunk 1001 is generated and uploaded by device A. The contents of the cloud data chunk 1001 and the edge data chunk 1002 may be the same as the cloud data chunk 901 and the edge data chunk 902 in FIG. 9A. Device B downloads and decrypts the cloud data chunk 1001 (referred to as the downloaded cloud data chunk 1003). The sync engine 920 in device B calculates an updated data chunk 1004 based on the two data chunks 1002 and 1003. In one embodiment, the re-calculation may include calculating a new set of user’s preferences based on the two data chunks 1002 and 1003. The encryption module 910 then encrypts the updated data chunk 1004. Device B then uploads to the cloud 960 the encrypted and updated chunk (referred to as an U/L cloud data chunk 1005), which may contain updated user preferences. FIG. 10B shows that the cloud 960 before the synchronization stores the cloud data chunk 1001, and after the synchronization stores the U/L cloud data chunk 1005. After the synchronization, any of the user’s devices including device A and device B can download the U/L cloud data chunk 1005 for inference operations.

FIG. 11A and FIG. 11B illustrate another synchronization scenario in which a cloud data chunk 1101 and an edge data chunk 1102 completely overlap in a timeslot (T0-T1) according to one embodiment. When device B detects a data discrepancy between the edge data chunk 1102 and the cloud data chunk 1101, device B determines from the timeslot information of the two data chunks 1101 and 1102 that the edge data chunk 1102 begins before and ends after the cloud data chunk 1101 in the timeslot. That is, the edge data chunk 1102 completely covers the cloud data chunk 1101 in the timeslot. In one embodiment, the encryption module 910 encrypts the edge data chunk 1102. Device B then uploads to the cloud 960 the encrypted edge data chunk (“uploaded cloud data chunk 1105”). FIG. 11B shows that the cloud 960 before the synchronization stores the cloud data chunk 1101, and after the synchronization stores the uploaded cloud data chunk 1105. After the synchronization, any of the user’s devices can download the U/L cloud data chunk 1105 for inference operations.

In an alternative scenario where the cloud data chunk 1101 begins before and ends after the edge data chunk 1102 in the timeslot (i.e., the cloud data chunk 1101 completely covers the edge data chunk 1102 in the timeslot), device B may download and decrypt the cloud data chunk 1101 to replace the edge data chunk 1102 for future inference operations. The cloud data chunk 1101 stays the same in the cloud 960 before and after the synchronization, and can be downloaded by any of the user’s devices for inference operations.

In one embodiment, the synchronization of a user’s devices may be performed sequentially or concurrently. For example, the user’s devices may be queued for synchronization. For data chunks with overlapped portions in a timeslot, only one device can synchronize with the cloud at a time. For data chunks without overlapped portions in a timeslot, multiple devices can synchronize with the cloud concurrently. To reduce the impact of synchronization overhead on agentic experiences, the frequency of synchronization can be arranged according to a fixed schedule, e.g., at a predetermined time every day, or can be event-based, e.g. every time the device is connected to a cloud server.

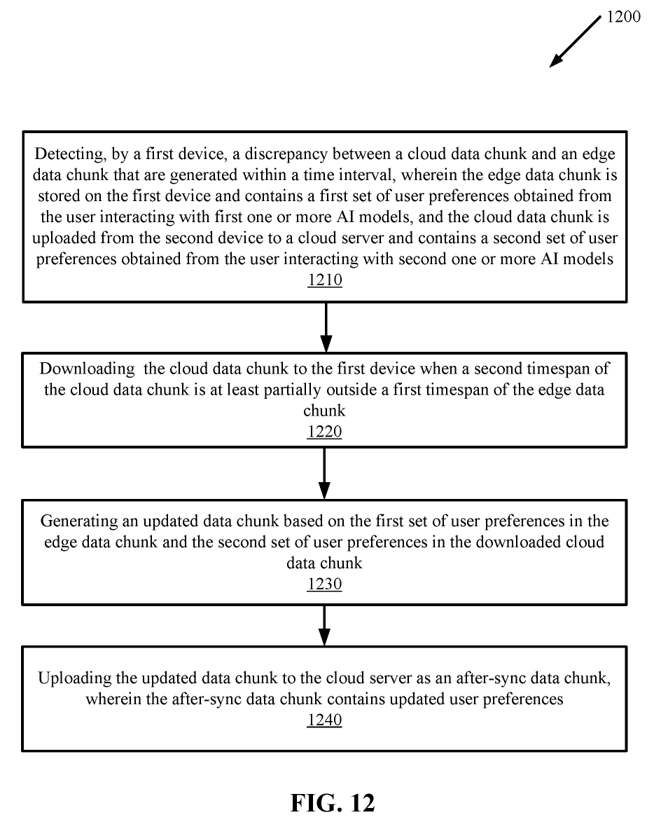

FIG. 12 is a flow diagram illustrating a method 1200 for agentic data synchronization between devices of a user according to one embodiment. The method 1200 begins when a first device at step 1210 identifies a discrepancy between a cloud data chunk and an edge data chunk, both of which are generated within a time interval. The edge data chunk is stored on the first device and contains a first set of user preferences obtained from the user interacting with first one or more AI models, and the cloud data chunk is uploaded from a second device to a cloud server and contains a second set of user preferences obtained from the user interacting with second one or more AI models. At step 1220, the first device downloads the cloud data chunk when a second timespan of the cloud data chunk is at least partially outside a first timespan of the edge data chunk. The first device at step 1230 generates an updated data chunk based on the first set of user preferences in the edge data chunk and the second set of user preferences in the downloaded cloud data chunk. Then the first device at step 1240 uploads the updated data chunk to the cloud server as an after-sync data chunk. The after-sync data chunk contains updated user preferences.

In one embodiment, when generating the updated data chunk, the first device uses an LLM to extract a new set of user preferences from the edge data chunk in the first timespan and the downloaded cloud data chunk in the second timespan. In one embodiment, the first device uses an LLM to summarize the first set of user preferences and the second set of user preferences. In one embodiment, the updated user preferences include a summary of the first set of user preferences in the first timespan and the second set of user preferences in the second timespan when the first timespan and the second timespan have no overlap. In one embodiment, the updated user preferences merges the first set of user preferences and the second set of user preferences when the first timespan and the second timespan overlap or have a predetermined time gap therebetween.

In one embodiment, the first device encrypts and uploads the edge data chunk as the after-sync data chunk when the first timespan completely covers the second timespan. In one embodiment, the first device designates the cloud data chunk as the after-sync data chunk when the second timespan completely covers the first timespan. In one embodiment, the first device decrypts the downloaded cloud data chunk and encrypts the updated data chunk. In one embodiment, the first device compares hash values of the cloud data chunk and the edge data chunk to detect the discrepancy between the cloud data chunk and the edge data chunk.

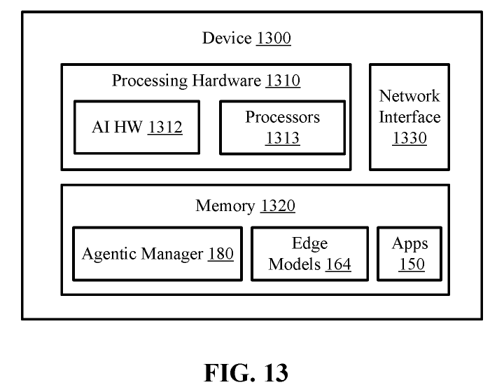

FIG. 13 is a block diagram illustrating a device 1300 in an agentic system according to one embodiment. The device 1300 may be one of the nodes in a distributed agentic framework or a distributed agentic system described with reference to FIG. 1–FIG. 5. The device 1300 may alternatively be a standalone device that performs the operations of an agentic system. In some embodiments, the device 1300 may be any device that performs the aforementioned operations of an agentic manager, such as the embodiments shown in FIG. 9 and FIG. 11.

The device 1300 includes processing hardware 1310, which further includes processors 1313 and AI hardware 1312. Non-limiting examples of the processors 1313 include a central processing unit (CPU), a graphic processing unit (GPU), a digital signal processor, a media processor, etc. The processors 1313 may perform the operations of the agentic manager 180. The device 1300 further includes a memory 1320 such as a static random-access memory (SRAM) device, a dynamic random-access memory (DRAM) device, a flash memory device, and/or other volatile or non-volatile memory devices. The memory 1320 may store machine-executable instructions for the processors 1313 to perform the operations of the agentic manager 180. In some embodiments, the memory 1320 may also store agentic framework components, such as system functions 110, apps 150, edge models 164, databases 172 and 173, user interfaces 191, 192, and/or 193 (FIG. 1). Not all of the agentic framework components are shown in FIG. 13.

The device 1300 may further include a network interface 1330, which may be a wired interface and/or a wireless interface. It is understood that the device 1300 is simplified for illustration purposes; additional hardware and software components are not shown.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method performed by a device, comprising:
sending a plurality of predefined requests to each of a plurality of artificial intelligence (AI) models deployed on the device;
obtain, from inference operations of each AI model for each predefined request, a multi-dimensional complexity vector indicating, in each dimension, a complexity value of the inference operations;
evaluating an agentic level provided by each AI model by calculating a combination of complexity values obtained from each predefined request and averaging over the predefined requests;
estimating, when receiving a user request, a required agentic level of the user request; and
directing the user request to one of the AI models that provides the required agentic level.

2. The method of claim 1, wherein one of the complexity values indicates a total number of actions of apps and services triggered by a given AI model in response to a predefined request.

3. The method of claim 1, wherein one of the complexity values indicates a total number of apps and services triggered by a given AI model in response to a predefined request.

4. The method of claim 1, wherein one of the complexity values indicates a total number of user interactions between a user and a given AI model when the given AI model responds to a predefined request.

5. The method of claim 1, wherein the complexity values indicate an amount of user profile data and an amount of contextual data used by a given AI model for inference in response to a predefined request.

6. The method of claim 1, wherein the required agentic level of the user request is estimated based on a predefined request category to which the user request belongs.

7. The method of claim 1, wherein calculating the combination of complexity values further comprises:
adding, for each predefined request, all complexity values in the multi-dimensional complexity vector to obtain a sum.

8. The method of claim 1, further comprising:
activating one or more of the AI models that provide a given agentic level supported by the device.

9. A device, comprising:
memory to store a plurality of artificial intelligence (AI) models; and
one or more processors coupled to the memory, the one or more processors operative to:
send each AI model a plurality of predefined requests to obtain, for each predefined request, a multi-dimensional complexity vector indicating, in each dimension, a complexity value of AI operations;
evaluate an agentic level provided by each AI model by calculating a combination of complexity values obtained from each predefined request and averaging over the predefined requests;
estimate, when receiving a user request, a required agentic level of the user request; and
direct the user request to one of the AI models that provides the required agentic level.

10. The device of claim 9, wherein one of the complexity values indicates a total number of actions of apps and services triggered by a given AI model in response to a predefined request.

11. The device of claim 9, wherein one of the complexity values indicates a total number of apps and services triggered by a given AI model in response to a predefined request.

12. The device of claim 9, wherein one of the complexity values indicates a total number of user interactions between a user and a given AI model when the given AI model responds to a predefined request.

13. The device of claim 9, wherein the complexity values indicate an amount of user profile data and an amount of contextual data used by a given AI model for inference in response to a predefined request.

14. The device of claim 9, wherein the one or more processors are operative to add, for each predefined request, all complexity values in the multi-dimensional complexity vector to obtain a sum.

15. The device of claim 9, wherein the required agentic level of the user request is estimated based on a predefined request category to which the user request belongs.

16. The device of claim 9, wherein the one or more processors are operative to activate one or more of the AI models that provide a given agentic level supported by the device.

17. A method performed by an agentic manager on a device, comprising:
prompting a remote artificial intelligence (AI) model to perform reasoning operations based on a user request;
prompting an edge AI model on the device to perform action planning operations based on an output of the reasoning operations;
sending action requests to one or more apps and services according to an action plan generated by the edge AI model; and
generating a response to the user request based on outputs of the one or more apps and services.

18. The method of claim 17, wherein prompting the edge AI model further comprises:
sending privacy information stored on the device to the edge AI model for the action planning operations.

19. The method of claim 17, wherein the remote AI model resides on a cloud server communicatively coupled to the device.

20. The method of claim 17, wherein the remote AI model resides on another device communicatively coupled to the device.
